(19) United States
(12) Patent Application Publication
(10) Pub. No.: US 2012/0316723 A1
(43) Pub. Date: Dec. 13, 2012

(54) method for determining at least one trafficable area in the surroundings of a motor vehicle

(76) Inventors: Jorge Sans Sangorrin, Struttgart (DE); Jan Sparbert, Rutesheim (DE); Wolfgang Branz, Ludwigsburg (DE); Andreas Simon, Wolfenbuettel (DE); Paul-Sebastian Lauer, Hannover (DE)

(21) Appl. No.: 13/500,704

(22) PCT Filed: Sep. 1, 2010
(86) PCT No.: PCT/EP2010/062803

§ 371 Date: Jun. 22, 2012

(30) Foreign Application Priority Data
Oct. 14, 2009 (DE) 102009045661.9

(51) Int. Cl. G08G 1/16; G05D 1/02

(52) U.S. Cl. 701/23; 701/301

(57) ABSTRACT

In a method for determining at least one trafficable area in the surroundings of a motor vehicle relevant for vehicle guidance, e.g., for ascertaining an evasion trajectory for a driver assistance system of the motor vehicle, at least one object detection sensor of the vehicle detects objects or obstacles in the surroundings of the motor vehicle, and the chronological sequence of occupancy information of the at least one object detection sensor of the motor vehicle regarding at least one detected object is taken into consideration.

### BACKGROUND OF THE INVENTION

1. Field of the Invention

The present invention relates to a device and a method for determining at least one trafficable area in the surroundings of a motor vehicle.

2. Description of Related Art

Surroundings-sensing technology is becoming increasingly important for driver assistance systems. For example, radar sensors, lidar sensors, ultrasound sensors, or camera systems are used in this context. The sensor data are analyzed and interpreted using downstream algorithms. The interpretation result is then transmitted to the driver assistance systems, which then initiate the corresponding vehicle actions.

The trafficability of areas is also relevant for driver assistance systems that evade obstacles in an automated manner (e.g., under consideration of a previously ascertained evasion trajectory). This information may be ascertained using a sensor that provides data explicitly from the plane in the surroundings of a motor vehicle that are relevant for vehicle guidance in particular. If the sensor detects locations or objects in the vehicle surroundings, areas in which no objects were detected are not necessarily trafficable; rather there is generally no explicit knowledge regarding trafficability in these areas.

Published German patent application document DE 10 2004 056 120 A1 relates to a method for preventing a collision or minimizing the consequences of a collision during travel when a motor vehicle approaches an obstacle, in particular a preceding vehicle.

Published German patent application document DE 10 2005 026 386 A1 describes a method and a device for determining open areas in the surroundings of a vehicle.

### BRIEF SUMMARY OF THE INVENTION

The method according to the present invention provides for determining at least one trafficable area in the surroundings of a motor vehicle that are relevant for vehicle guidance, e.g., for ascertaining an evasion trajectory for a driver assistance system of the motor vehicle, the motor vehicle having at least one object detection sensor for detecting objects or obstacles in the surroundings of the motor vehicle, the chronological sequence of occupancy information of at least one object detection sensor of the motor vehicle regarding at least one detected object being taken into consideration, has the advantage that information regarding the trafficability of areas of the vehicle surroundings may be derived from the chronological sequence of object detections in a simple manner, i.e., the trafficability information is estimated on the basis of the current and past object detections. The chronological sequence of the object information is analyzed and interpreted. The ascertained trafficability data may then be made available to driver assistance systems that are able to evade obstacles in an automated manner with the aid of an evasion trajectory. Additional information regarding trafficable terrain or areas is obtained by a simple situation interpretation based on object data. However, it is important that the at least one detected object is not in an accident situation or the like. The method according to the present invention may be advantageously used with an already existing sensor, in particular a long-range radar sensor, which abstracts the description of the surroundings using so-called object lists or location lists, for example.

The at least one trafficable area may be determined by analyzing and interpreting the occupancy information of the at least one object detection sensor of the motor vehicle regarding the at least one detected object at a current point in time and at least one previous point in time.

At least one sensor for surroundings sensing is capable of detecting occupied areas within its detection range and ideally using this information to provide the probability that these areas are occupied. A radar sensor, a lidar sensor, or a video sensor may be used as the object-detecting sensor that draws conclusions regarding trafficable areas on the basis of the time movement of detected objects. The analysis and interpretation of the occupancy information at the current point in time and at a previous point in time, i.e., where the currently detected objects were located (so-called object history), make it possible to determine whether an area is trafficable. The following methods may be used for this purpose.

Retrodiction of the occupancy information from the at least one object detection sensor of the motor vehicle regarding the at least one detected object for a predefined time interval may be performed. The length of the predefined time interval should be selected in such a way that the accuracy of the speed information and possibly the acceleration information is sufficiently high.

Alternatively or additionally, the occupancy information of the at least one object detection sensor of the motor vehicle regarding the at least one detected object may be interpolated continuously or successively in cycles.

A computer program having program code means and a computer program product having program code means stored on a computer-readable data carrier for carrying out the method according to the present invention are also provided.

The present invention also provides a device, e.g., a driver assistance system of a motor vehicle, for implementing the methods according to the present invention.

The method according to the present invention for determining at least one trafficable area in the surroundings of a motor vehicle that are relevant for vehicle guidance in particular or the method according to the present invention for motor vehicle collision prevention is preferably implemented as a computer program on a control unit of a driver assistance system of a motor vehicle, other approaches also being possible, of course. The computer program is stored in a storage element of the control unit. The method is executed by processing on a microprocessor of the control unit. The computer program may be saved on a computer-readable data carrier (diskette, CD, DVD, hard disk, USB memory stick, memory card, or the like) or an internet server as a computer program product and transferred from there to the storage element of the control unit.

### BRIEF DESCRIPTION OF THE DRAWINGS

FIG. 1 shows a schematic illustration for clarification of the method according to the present invention in a first specific embodiment.

FIG. 2 shows a schematic illustration for clarification of the method according to the present invention in a second specific embodiment.

### DETAILED DESCRIPTION OF THE INVENTION

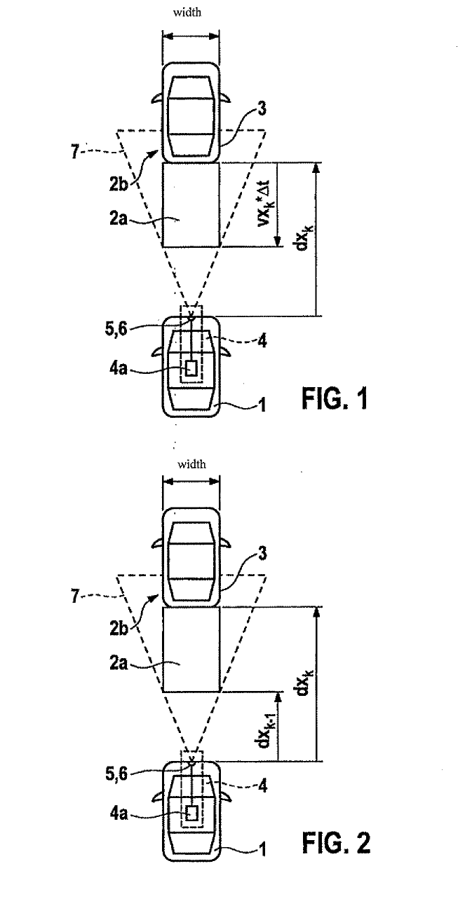

FIG. 1 shows a motor vehicle 1 for which the method according to the present invention for determining at least one trafficable area 2 in the surroundings of motor vehicle 1 that are relevant for vehicle guidance, in particular for determining an evasion trajectory (not shown), is implemented. This may be carried out as part of a method for collision prevention for motor vehicle 1 in which a driving maneuver of motor vehicle 1 for evasion is performed autonomously or semi-autonomously or is suggested in the case of an object or obstacle 3 that is approaching the vehicle during travel and is located in an occupied area 2b. The driving maneuver is based on a collision-preventing evasion trajectory ascertained under consideration of trafficable areas 2a determined with the aid of the method for determining trafficable areas 2a in the surroundings of motor vehicle 1. Based on this, a device for carrying out the method according to the present invention designed as a driver assistance system 4 may support the driver during evasion of obstacles 3 and in the case of an impending collision guide the driver autonomously or semi-autonomously to a safe trajectory that does not collide with any obstacle 3 surrounding motor vehicle 1. This may be performed, on the one hand, by displaying an appropriate warning or, on the other hand, by the active intervention of driver assistance system 4 with the aid of a corrective braking intervention via a targeted brake force increase or with the aid of an appropriate steering intervention via a steering system (not shown) of motor vehicle 1.

Motor vehicle 1 or driver assistance system 4 has a radar sensor 5, in particular a long-range sensor, as a surroundings-sensing sensor system or object detection sensor for metrologically detecting the traffic situation or the surroundings of motor vehicle 1. In another exemplary embodiment, the object detection sensor may also be designed as a lidar sensor or the like. Of course, other sensor types may also be used. With corresponding changes, multiple sensors as well as combinations of different sensors may be used.

As a result of a combination with sensors that also provide information about object extension or width (see FIGS. 1 and 2), such as an additionally provided video sensor 6 (e.g., CMOS or CCD sensor), trafficable and occupied areas 2a, 2b or terrain in the surroundings of motor vehicle 1 may be determined more precisely and completely in a very advantageous manner.

Detection cones 7 of radar sensor 5 are indicated by a dashed line in FIGS. 1 and 2. In further exemplary embodiments (not shown), a surroundings sensor system for detecting the traffic situation behind motor vehicle 1 may be provided.

Radar sensor 5 or video sensor 6 is connected to control unit 4a of driver assistance system 4 having an evaluation module not shown in greater detail. Objects or obstacles 3 may be detected on the basis of the sensor signals of radar sensor 5 using control unit 4a. As part of driver assistance system 4, the method for collision prevention for motor vehicle 1 runs on control unit 4a, a driving maneuver of motor vehicle 1 for evasion being performed autonomously or semi-autonomously or being suggested to the driver via a warning device or via additional vehicle systems in the case of an obstacle 3 approaching the vehicle during travel. The driving maneuver is based on a collision-preventing evasion trajectory ascertained under consideration of trafficable areas 2a determined with the aid of the method according to the present invention for determining at least one trafficable area 2a in the surroundings of motor vehicle 1. The chronological sequence of occupancy information of the at least one object detection sensor 5, 6 of motor vehicle 1 regarding detected object 3 is taken into consideration in this process.

The at least one trafficable area 2a is determined via analysis and interpretation of the occupancy information of the at least one object detection sensor 5, 6 of motor vehicle 1 regarding the at least one detected object 3 at a current point in time k and at least one previous point in time k−1.

As is apparent from FIG. 1, retrodiction of the occupancy information of the at least one object detection sensor 5, 6 of motor vehicle 1 regarding the at least one detected object 3 for a predefined time interval Δt is performed. In this context Δt refers to the time interval between previously mentioned points in time k−1 and k. dxₖ refers to the measured distance in the longitudinal direction at current point in time k. The traversed terrain or trafficable area 2a may now be predicted on the basis of the width of detected object 3 detected by video sensor 6, for example, and the distance in the longitudinal direction at previous point in time k−1 resulting from the product of predefined time interval Δt and the current speed of object 3 in longitudinal direction vxₖ. In the present case, retrodiction is understood to be the prediction of a former but unknown state. The length of predefined time interval Δt is selected in such a way that sufficiently high precision of the speed information or the acceleration information regarding the at least one detected object 3 is achieved.

FIG. 2 shows an alternatively or additionally usable specific embodiment of the method according to the present invention. In FIGS. 1 and 2 identical reference numerals relate to elements with the same function. Therefore, the occupancy information of the at least one object detection sensor 5, 6 of motor vehicle 1 regarding the at least one detected object 3 may be interpolated continuously or successively in cycles. The traversed terrain or trafficable area 2a may be determined on the basis of the width of detected object 3 detected by video sensor 6, for example, and continuously interpolated distance dxₖ₋₁ in the longitudinal direction at previous point in time k−1.

The method according to the present invention for determining at least one trafficable area 2a in surroundings 2 of motor vehicle 1 that are relevant for vehicle guidance or the method according to the present invention for collision prevention for motor vehicle 1 is preferably implemented as a computer program on control unit 4a of a driver assistance system 4 of motor vehicle 1, other approaches also being possible, of course. The computer program is stored in a storage element (not shown) of control unit 4a. The method is executed by processing on a microprocessor (not shown) of control unit 4a. The computer program may be saved on a computer-readable data carrier (diskette, CD, DVD, hard disk, USB memory stick, memory card, or the like) or an internet server as a computer program product and transferred from there to the storage element of control unit 4a.

1-9. (canceled)

10. A method for determining at least one trafficable area in the surroundings of a motor vehicle for ascertaining an evasion trajectory for a driver assistance system of the motor vehicle, comprising:
detecting, using at least one object detection sensor of the motor vehicle, at least one object in the surroundings of the motor vehicle; and
using a chronological sequence of space-occupancy information regarding the at least one detected object from the at least one object detection sensor to determine the at least one trafficable area.

11. The method as recited in claim 10, wherein the at least one trafficable area is determined by analyzing the space-occupancy information from the at least one object detection sensor regarding the at least one detected object at a current point in time and at least one previous point in time.

12. The method as recited in claim 11, wherein retrodiction of the space-occupancy information from the at least one object detection sensor of the motor vehicle regarding the at least one detected object for a predefined time interval is performed.

13. The method as recited in claim 12, wherein the length of the predefined time interval is selected in such a way that a sufficiently high precision of speed information and acceleration information regarding the at least one detected object is achieved.

14. The method as recited in claim 12, wherein interpolation of the space-occupancy information from the at least one object detection sensor regarding the at least one detected object is performed continuously in cycles.

15. A method for collision prevention for a motor vehicle, comprising:
determining at least one trafficable area in the surroundings of the motor vehicle, by:
detecting, using at least one object detection sensor of the motor vehicle, at least one object in the surroundings of the motor vehicle; and
using a chronological sequence of space-occupancy information regarding the at least one detected object from the at least one object detection sensor to determine the at least one trafficable area;
ascertaining a collision-preventing evasion trajectory for a driver assistance system of the motor vehicle by taking into account the at least one trafficable area; and
automatically controlling a driving maneuver of the motor vehicle in the case of approaching the at least one object during travel, wherein the automatically controlled driving maneuver is based on the ascertained collision-preventing evasion trajectory.

16. A non-transitory computer-readable data storage medium storing a computer program having program codes which, when executed on a computer, performs a method for collision prevention for a motor vehicle, the method comprising:
determining at least one trafficable area in the surroundings of the motor vehicle, by:
detecting, using at least one object detection sensor of the motor vehicle, at least one object in the surroundings of the motor vehicle; and
using a chronological sequence of space-occupancy information regarding the at least one detected object from the at least one object detection sensor to determine the at least one trafficable area;
ascertaining a collision-preventing evasion trajectory for a driver assistance system of the motor vehicle by taking into account the at least one trafficable area; and
automatically controlling a driving maneuver of the motor vehicle in the case of approaching the at least one object during travel, wherein the automatically controlled driving maneuver is based on the ascertained collision-preventing evasion trajectory.

17. A driver assistance system of a motor vehicle, comprising:
at least one object detection sensor of the motor vehicle for detecting at least one object in the surroundings of the motor vehicle; and
a control unit connected to the at least one object detection sensor, wherein the control unit is configured to:
determine at least one trafficable area in the surroundings of the motor vehicle by using a chronological sequence of space-occupancy information regarding the at least one detected object from the at least one object detection sensor;
ascertain a collision-preventing evasion trajectory by taking into account the at least one trafficable area; and
automatically control a driving maneuver of the motor vehicle in the case of approaching the at least one object during travel, wherein the automatically controlled driving maneuver is based on the ascertained collision-preventing evasion trajectory.
